(19) United States
(12) Patent Application Publication
(10) Pub. No.: US 2015/0363745 A1
(43) Pub. Date: Dec. 17, 2015

(54) BLUETOOTH VERIFIED SMARTPHONE CLOCK-IN

(71) Applicant: Vivint, Inc., Provo, UT (US)

(72) Inventors: Brandon Gordon Hatch, Provo, UT (US); Aaron Christian Montague, St. George, UT (US); Colby Winegar, Draper, UT (US); Ryan A. Caplin, Santa Clara, UT (US)

(21) Appl. No.: 14/304,783

(22) Filed: Jun. 13, 2014

(51) Int. Cl. G06Q 10/10; H04W 4/04; H04W 64/00; H04L 29/08; H04W 4/02

(52) U.S. Cl. CPC G06Q 10/1091; H04L 67/10; H04W 4/021; H04W 64/00; H04W 4/04

(57) ABSTRACT

Methods and systems are described for employee clock-in using an automation and security system. According to at least one embodiment, a computer-implemented method for employee clock-in using an automation and security system includes confirming a location of a mobile computing device within a geographic zone, taking a photograph of a person carrying the mobile computing device, recording a time at which the photograph is taken, and clocking-in the person as an employee based at least in part on the photograph, the recorded time, and the location of the mobile computing device within the geographic zone.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of home automation and security products. Advancements in mobile devices allow users to monitor and/or control an aspect of a home or business. As home automation and security products expand to encompass other systems and functionality in the home, opportunities exist for using home automation and security products for employee clock-in, clock-out and other time entry functions.

### SUMMARY

Methods and systems are described for employee clock-in using an automation and security system. According to at least one embodiment, a computer-implemented method for employee clock-in using an automation and security system includes confirming a location of a mobile computing device within a geographic zone, taking a photograph of a person carrying the mobile computing device, recording a time at which the photograph is taken, and clocking-in the person as an employee based at least in part on the photograph, the recorded time, and the location of the mobile computing device within the geographic zone.

In one example, the method includes comparing the photograph with a stored photograph of an employee associated with the mobile computing device to confirm that the person is the employee. The method may include confirming presence of the mobile computing device using Bluetooth communication. The mobile computing device may include at least one employee identifier that is associated with the employee. The method may include tagging the photograph with the recorded time. The method may include receiving geo location information for the mobile computing device at the time the photograph is taken or when the person is clocked in as an employee. The method may include tagging the photograph with the geo location information. The method may include, after clocking-in the employee, confirming location of the mobile computing device within the geographic zone, taking another photograph of the person, recording a time at which the another photograph is taken, and clocking-out the person based at least in part on the photograph, the recorded time, and the confirmed location that occur after clocking-in the employee. The method may include generating at least one report showing hours worked by the employee during a predetermined time period based on clock-in and clock-out times. The method may include generating at least one report showing clock-in information for the employee for a predetermined time period. The method may include generating a notice if a time for the clock-in is after a scheduled shift start time for the employee.

Another embodiment is directed to an apparatus for employee clock-in using an automation and security system. The apparatus includes a processor, a memory in electronic communication with the processor, and instructions stored in the memory. The instructions are executable by the processor to establish a communication link between a mobile computing device and a control panel of the automation and security system when the mobile computing device is within a geographic zone of the control panel, confirm that a person carrying the mobile computing device is an employee, and clock-in the employee.

In one example, the instructions may be executable by the processor to take a photograph of the person carrying the mobile computing device as part of confirming that the person is the employee. The instructions may be executable by the processor to tag the photograph with at least one of time information and geo location information. The instructions may be executable by the processor to, after clocking-in the employee, re-establish the communication link between the mobile computing device and the control panel when the mobile computing device is within the geographic zone, confirm that the person carrying the mobile computing device is the employee, and clock-out the employee.

A further embodiment relates to a computer-implemented method for employee clock-in. The method includes confirming a location of a mobile computing device within a geographic zone of a control panel of an automation and security system, taking a photograph of a person with the mobile computing device, and clocking-in the person as an employee based at least in part on the photograph and the confirmed location.

In one example, the method includes tagging the photograph with a time that the photograph was taken. The method may include tagging the photograph with geo location information for the mobile computing device. The method may include transmitting the photograph to a control panel of the automation and security system. The method may include, after clocking-in the employee, confirming a location of the mobile computing device within the geographic zone of the control panel, taking another photograph of the person with the mobile computing device, and clocking-out the person based at least in part on the photograph and the confirmed location.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of another environment in which the present systems and methods may be implemented;

FIG. 3 is a block diagram of another environment in which the present systems and methods may be implemented;

FIG. 4 is a block diagram of another environment in which the present systems and methods may be implemented;

FIG. 5 is a block diagram of another environment in which the present systems and methods may be implemented;

FIG. 6 is a block diagram of an example clock-in module of the environments shown in FIGS. 1-5;

FIG. 7 is a block diagram of another example clock-in module of the environments shown in FIGS. 1-5;

FIG. 8 is a flow diagram illustrating a method for employee clock-in using an automation and security system;

FIG. 9 is a flow diagram illustrating another method for employee clock-in using an automation and security system;

FIG. 10 is a flow diagram illustrating another method for employee clock-in; and

FIG. 11 is a block diagram of a computer system suitable for implementing the present systems and methods of FIGS. 1-10.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to home automation and home security, and related security systems and automation for use in commercial and business settings. As used herein, the phrase “home automation and security system” may refer to a system that includes automation features alone, security features alone, a combination of automation and security features, or a combination of automation, security and other features. While the phrase “home automation and security system” is used throughout to describe a system or components of a system or environment in which aspects of the present disclosure are described, such a system and its related features (whether automation and/or security features) may be generally applicable to homes, businesses and commercial properties as well as systems that are used in indoor and outdoor settings.

The present disclosure relates to systems and methods for employee clock-in and/or clock-out. The systems and methods disclosed herein may also relate to identification of employees, employee identification confirmation, communications with an employee's supervisor, owner, or the like, and generating reports and/or notifications related to employee clock-in and/or clock-out events. In one example, the systems and methods described herein are directed to using a control panel of an automation and security system for employee clock-in and/or clock-out functions. The control panel may communicate with a mobile computing device carried by an employee as part of indicating an identity of the employee.

In at least some examples, a picture is taken of the employee as part of authenticating the identity of the employee. The picture may be taken by a camera that is integrated into the control panel or located in close proximity to the control panel. Alternatively, the camera may be part of the mobile computing device carried by the employee. The picture taken of the employee may include a time stamp. The time stamp may establish a time of check-in and/or check-out. Additionally, or alternatively, the time stamp associated with the picture may be used as a secondary authentication of the check-in and/or check-out time which has been established via another method such as, for example, manual entry of a code or other function at the control panel, or the like.

In other embodiments, the picture taken by the camera may also include a geo location stamp. The geo location stamp may establish a location of the employee and/or the mobile computing device carried by the employee. The geo location stamp may further confirm that the employee is in close proximity to the place of business, the control panel, or other clock-in/clock-out device at the check-in and/or check-out time or during a work shift.

The picture may be automatically stored on the control panel or at another location such as, for example, a database accessible by a supervisor, owner, or other interested party. The picture may be used to confirm the identity of the employee using, for example, an automated comparison of the picture to a stored picture of the employee, or a manual evaluation of the picture by someone who is aware of the employee's appearance.

The systems and methods disclosed herein may also relate to generating one or more reports associated with the clock-in and clock-out times of the employee. The reports may provide, for example, historical data concerning whether the employee has logged a minimum number of hours, or has been late for a scheduled check-in and/or check-out event. The reports may provide information such as, for example, particular combination of employees working during a given shift, the number of breaks and the length of breaks that any given employee has taken, or an overall number of hours logged by any group of employees (e.g., a department, a shift, etc.).

A further aspect of the present disclosure relates to generating notifications when specific events occur according to predetermined rules. For example, a notification may be sent to an employee's mobile computing device (e.g., smartphone) if the mobile computing device of the employee moves outside of a pre-determined range of the control panel specifically or the place of business generally. In another example, a notification is generated and sent to a supervisor, owner, or the like in the event that an employee is late, a combination of employees has occurred, an employee has begun generating overtime, or an unauthorized mobile computing device has entered the premises (e.g., as determined by a short wave sensor associated with the control panel).

The employee authentication features provided by the systems and methods described herein may be particularly useful for addressing false clock-in and clock-out situations. For example, in systems in which the employee clocks in by merely scanning an identification card, it is possible for “buddy punching” to occur in which one employee brings in a co-worker's identification card to falsely clock-in or clock-out for the absent employee. The systems and methods disclosed herein may use, at least in part, an employee's mobile computing device (e.g., cell phone or smartphone) as part of clocking-in or clocking-out the employee. Including the employee's mobile handheld device in the clock-in/clock-out process is particularly effective because it is rare that someone is not carrying a mobile computing device at all times. Furthermore, the implementation of a captured image (e.g., picture) of the employee at the time of clock-in and/or clock-out, whether the picture is taken by the control panel or the user's own mobile computing device, provides further employee identification verification that addresses the concern of “buddy punching” and other fraudulent practices.

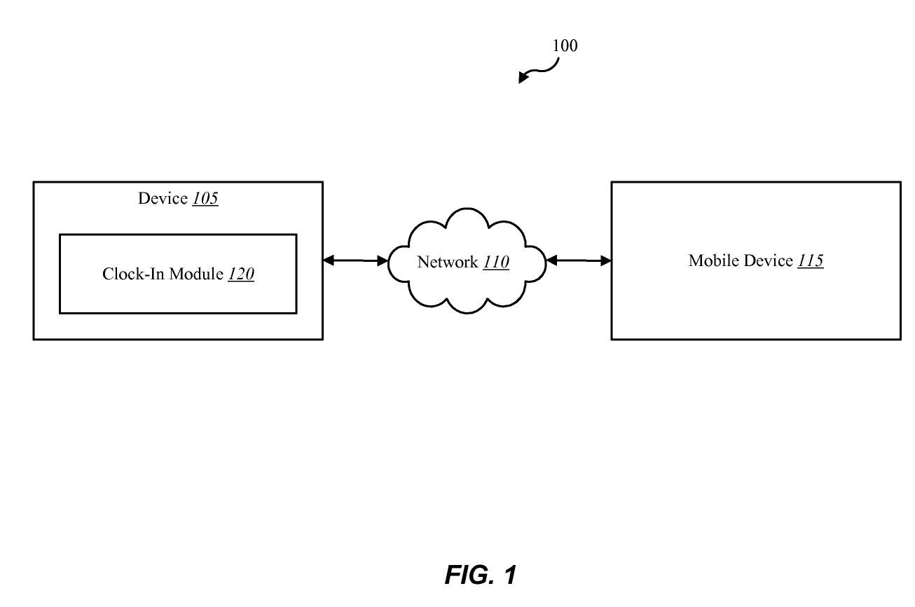

FIG. 1 is a block diagram illustrating one embodiment of an environment 100 in which the present systems and methods may be implemented. In some embodiments, the systems and methods described herein may be performed at least in part using a device 105 that communicates with a mobile device 115 via a network 110. Device 105 may include a clock-in module 120.

In some embodiments, device 105 may include or be part of a control panel of an automation and security system. Device 105 may operate to sense the location of mobile device 115 via, for example, a short wave technology such as, for example, Bluetooth, radio frequency (RF), or near field communication (NFC) technology. Identifying the presence of mobile device 115 may be used as part of confirming the identification of an employee who is associated with (e.g., pre-registered) with mobile device 115. The employee may clock-in and/or clock-out using any number of different systems and methods. Using a short wave technology to identify the location of mobile device 115 indicates a close proximity of mobile device 115 (and presumably the employee associated with the mobile device 115) to device 105. Pairing the proof of close proximity of mobile device 115 with other steps of the clock-in and/or clock-out process may provide the desired level of employee authentication to confirm that the intended employee is physically present when clocking-in and/or clocking-out.

Clock-in module 120 may operate to identify the presence of mobile device 115. For example, clock-in module 120 may include a short wave receiver that receives short wave transmissions provided by mobile device 115. In other embodiments, clock-in module 120 includes a transmitter that communicates with mobile device 115, and mobile device 115 communicates via another technology (e.g., Bluetooth) with device 105 and/or clock-in module 120 to confirm the location of mobile device 115. In one example, clock-in module 120 operates to prompt mobile device 115 to generate a notification that the person carrying mobile device 115 must respond to as part of a clock-in and/or clock-out. A notification may be in the form of, for example, a text message, an audible message, a displayed inquiry that can be responded to on a touch screen of mobile device 115, or message conveyed by an app operated by mobile device 115.

In other embodiments, mobile device 115 may include a geo location feature such as, for example, GPS. The GPS data from mobile device 115 may be communicated to device 105 and used by clock-in module 120 as part of confirming location of the mobile device 115 (and presumably the employee associated with mobile device 115) as part of the employee's clock-in and/or clock-out process. The geo location data may be referred to as long-wave data or technology as compared to the short wave communication mediums discussed above. In one example, if the mobile device 115 is not in close enough proximity to device 105 as determined based on the GPS data for a mobile device 115, clock-in module 120 may refuse to clock-in and/or clock-out the employee. Additionally, or alternatively, a geographic boundary may be established based on other criteria besides proximity to device 105 including, for example, a perimeter of the property of the place of business, or the like.

Network 110 may provide communication between device 105 and mobile device 115. Examples of network 110 include cloud networks, local area networks (LAN), wide area networks (WAN), virtual private networks (VPN), wireless networks using (using 802.11, for example) and/or cellular networks (using 3G and/or LTE, for example), etc. In some embodiments, network 110 may include the Internet. As discussed above, Network 110 may include a short wave technology such as, for example, Bluetooth, RF, NFC, ANT, Wi-Fi, irDA and the like technologies.

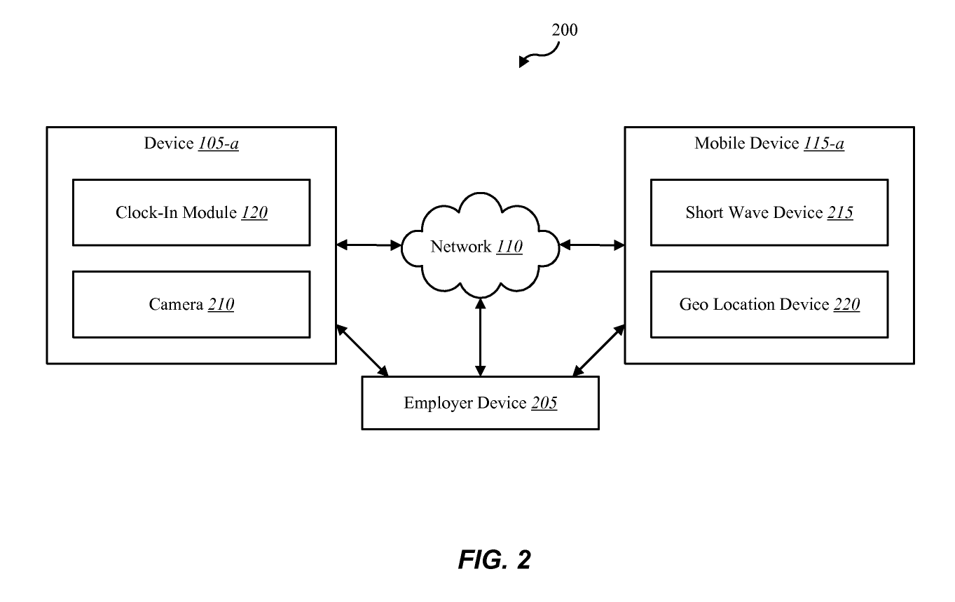

FIG. 2 is a block diagram illustrating one embodiment of an environment 200 in which the presents systems and methods may be implemented. Environment 200 may include at least some of the same components of environment 100 described above. In some embodiments, environment 200 may include a device 105-a that communicates with a mobile device 115-a via network 110. Device 105-a and/or mobile device 115-a may communicate with an employer device 205 directly or via network 110. Device 105-a may include a clock-in module 120 and camera 210. Mobile device 115-a may include a short wave device 215 and a geo location device 220.

Camera 210 may operate as part of a process for clocking-in or clocking-out an employee by taking a picture of the employee. The picture may be used by clock-in module 120 to confirm the identity of the person clocking-in and/or clocking-out, which may be the person carrying mobile device 115-a. The picture from camera 210 may be transmitted to employer device 205. Employer device 205 may include, for example, a desktop computer or a mobile computing device. An employer may manually inspect the picture of the person clocking-in and/or clocking-out to confirm the person's identity.

Camera 210 is shown as a component of device 105-a. In other embodiments, camera 210 may be provided as a separate component from device 105-a. Camera 210 may be mounted in close proximity to device 105-a. In some examples, camera 210 may be integrated into other components of the automation and security systems such as, for example, a security camera. Camera 210 may generate still shot photographs or may generate video content (e.g., from which still shots are taken).

Short wave device 215 may provide communication between device 105 and mobile device 115-a. Short wave device 215 may generate a signal that is received by device 105-a via, for example, clock-in module 120 and/or a short wave receiver provided separate from clock-in module 120. Short wave device 215 may automatically communicate with device 105-a when mobile device 115 moves within a predetermined area or zone relative to device 105-a. Device 105-a may include a sensor that identifies the presence of mobile device 115-a in response to signals from short wave device 215. The sensor of device 105-a may be referred to as a proximity sensor.

When short wave device 215 moves out of the relatively small zone in proximity to device 105-a, clock-in module 120 may assume that the employee carrying mobile device 115-a intended to clock-out and automatically clocks-out the employee. In other examples, clock-in module 120 may generate a notice sent to employer device 105 when short wave device 215 moves out of the zone in proximity to device 105-a, particularly if the employee carrying mobile device 115-a has not clocked-out. In other examples, a notification is sent to the employee carrying mobile device 115-a via, for example, the mobile device 115-a in the event that the employee has not clocked-out but has moved outside of the proximity range of device 105-a.

The signals transmitted by a short wave device 215 may include an identification code associated with mobile device 115-a and/or the employee who carries mobile device 115-a. Communications between device 105-a and mobile device 115-a facilitated by shortwave device 215 may be referred to as, for example, linking, connecting, syncing, identifying and/or pairing.

Geo location device 220 may use a different technology from short wave device 215 to identify a geographic location for mobile device 115-a. Geo location device 220 may determine a location of mobile device 115-a independent of device 105-a and its components and/or functionality. The geo location of mobile device 115-a determined by geo location device 220 may be conveyed to device 105-a in any number of ways. For example, geo location device 220 may provide a geo location automatically upon device 105-a and mobile device 115-a linking when mobile device 115-a moves within a certain zone or proximity of the device 105-a. The geo location of mobile device 115 may be associated with the photograph of the employee (i.e., personal carrying mobile device 115-a), a clock-in or clock-out function of the employee, and the like. The geo location device 220 may utilize, for example, GPS technology or some other long-wave technology.

Mobile device 115-a may communicate directly with employer device 205 to provide at least some of the information provided by short wave device 215 and/or geo location device 220 without routing that information through device 105-a. In one example, the picture provided by camera 210 may be combined with geo location information provided by geo location device 220 at the employer device 205. The employer, supervisor, or other person monitoring the employer device 205 may then assimilate and/or evaluate the picture and geo location information to make determinations related to the employee, such as, for example, confirmation of the employee's identification at clock-in and/or clock-out. Employer device 205 may be located on the same property as device 105-a. Alternatively, employer device 205 may be located remotely, and may include a mobile device. In at least one example, an employer may provide instructions to clock-in module 120 in response to receiving information from, for example, camera 210 and/or geo location device 220 (e.g., to prohibit clocking-in and/or clocking-out of the employee because of false and/or suspicious information related to the identity of the employee). In other examples, employer device 205 may generate and/or send a notice to mobile device 115-a or through other mediums to communicate with the employee in response to the information received from one of device 105-a and mobile device 115-a.

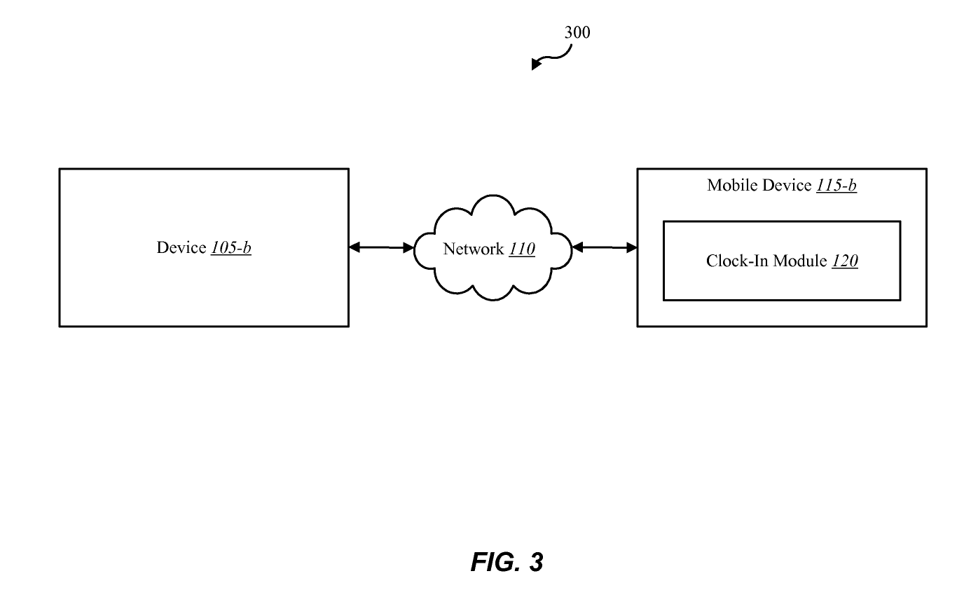

FIG. 3 is a block diagram illustrating one embodiment of an environment 300 in which the present systems and methods may be implemented. Environment 300 may include components of environments 100, 200 described above. In some embodiments, the systems and methods described herein may be performed at least in part on or using a device 105-b and a mobile device 115-b. Mobile device 115-b may include or operate clock-in module 120. Device 105-b and mobile device 115-b may communicate via network 110. Device 105-b may operate to determine that mobile device 115-b is within a pre-determined proximity or zone relative to device 105-b. This identification (also referred to as a linking, pairing, or the like) may be used by clock-in module 120 as part of confirming a location of mobile device 115-b, and presumably the location of an employee associated with mobile device 115-b as part of clocking-in and/or clocking-out the employee.

Clock-in module 120 may receive inputs from a variety of sources as part of a clock-in and/or clock-out process. Clock-in module 120 may operate to determine and/or confirm an identity of the employee and/or person carrying mobile device 115-b as part of the clock-in and/or clock-out process. Clock-in module 120 may communicate with device 105 as part of the clock-in and/or clock-out process, or the process of confirming identity of one or more employees. In at least some examples, both device 105-b and mobile device 115-b include a clock-in module 120 and/or components thereof, which are operable for clocking-in and/or clocking-out an employee.

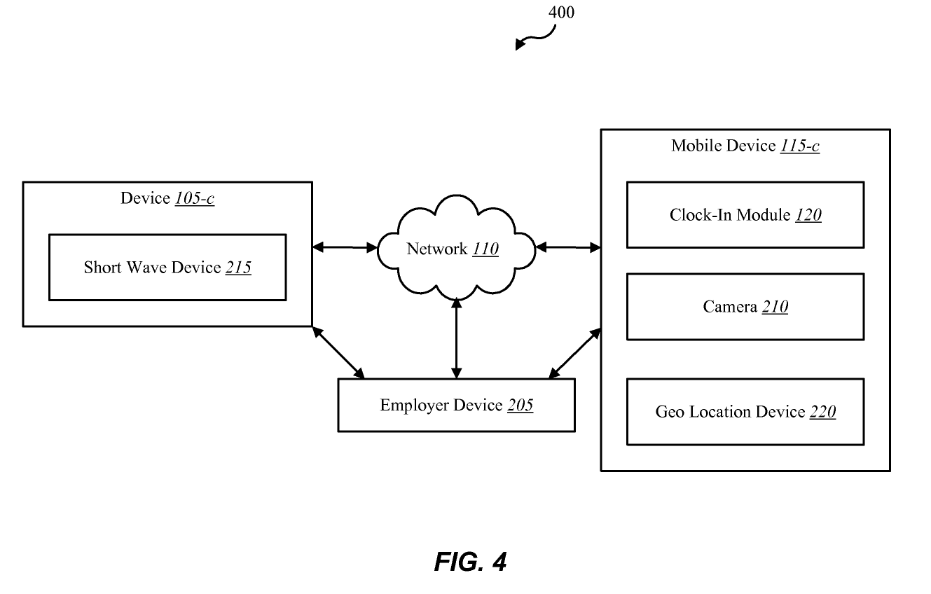

FIG. 4 is a block diagram illustrating one embodiment of an environment 400 in which the present systems and methods may be implemented. Environment 400 may include at least some of the same components as environments 100, 200, 300 described above. In some embodiments, the systems and methods described herein may be performed at least in part on or using a device 105-c, a mobile device 115-c, and an employer device 205, which may communicate with each other via network 110. Device 105-c includes a shortwave device 215. Mobile device 115-c includes clock-in module 120, a camera 210, and geo location device 220. Environment 400 shows at least some of the components that may be operated by or located in close proximity to device 105 and may be integrated into or used in connection with mobile device 115. For example, camera 210 may be a component of mobile device 115-c and operable to take a picture of the employee as part of a clock-in and/or clock-out procedure. The picture from camera 210 may be evaluated by clock-in module 120 as part of, for example, confirming an identity of the employee. Alternatively, the picture may be transmitted to employer device 205 directly or via network 110. Employer device 205, as discussed above, may provide the employer with the picture of the employee for purposes of confirming identification of the employee either manually or automatically.

Geo location device 220 may provide geo location information from mobile device 115-c, which is assumed to be carried by an employee that has been pre-registered or otherwise associated with mobile device 115-c. The geo location information from geo location device 220 may be used by clock-in module 120 to stamp or tag the picture taken by camera 210 as part of confirming that the employee is at the place of business (e.g., in close proximity to device 105-c) at the time of clock-in and/or clock-out.

The automation and security system of environment 400 may provide linking or coupling of device 105-c and mobile device 115-c via signals from shortwave device 215. Shortwave device 215 may facilitate communication between device 105-c and mobile device 115-c that is used to confirm that mobile device 115-c, and presumably the employee associated with mobile device 115-c, is physically located at the place of business. Clock-in module 120 or other components of mobile device 115-c (e.g., a shortwave receiver or sensor) may use the information about the coupling of device 105-c and mobile device 115-c as part of clocking-in and/or clocking-out the employee associated with mobile device 115-c.

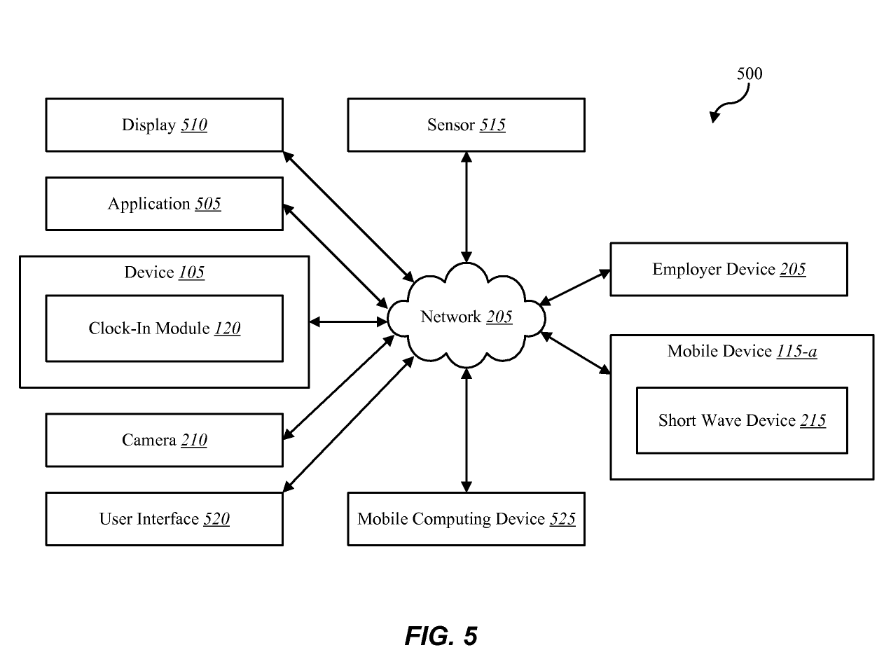

FIG. 5 is a block diagram illustrating one embodiment of an environment 500 in which the present systems and methods may be implemented. Environment 500 may include at least some of the same components of environments 100, 200, 300, 400 described above with reference to FIGS. 1-4. In some embodiments, the systems and methods described herein may be performed at least in part on or using device 105, mobile device 115-a, employer device 205, and camera 210. Environment 500 may also include an application 505, display 510, sensor 515, user interface 520, and mobile computing device 525. Any of the components shown in environment 500 may be used in combination with any of the other environments 100, 200, 300, 400 described herein.

Application 505 may allow a user (e.g., a user interfacing directly with device 105 and/or mobile device 115-a located at a property being monitored by the automation and security system) to control, either directly or via device 105, mobile device 115-a, or employer device 205, an aspect of the monitored property including security, energy management, locking and unlocking doors, checking the status of the door, locating the user or item, controlling lighting, thermostat, or cameras and receiving notification regarding a current status or anomaly associated with a home, office, place of business and the like (e.g., a property) in some configurations, application 505 may enable device 105, mobile device 115-a, and/or employer device 205 to communicate with each other and other components of environment 500, and provide the user interface 520 to display an automation, security and/or management content on one of device 105 and/or mobile device 115-a. Thus, application 505, via user interface 520, may allow users to control aspects of their home, office, and/or other type of property. Further, application 505 may be installed on one of devices 105, mobile device 115 and employer device 205, or other components and/or features of the automation and security system. Application 505 may facilitate generation of an alarm/notification in response to communications between device 105 and mobile device 115 based at least in part on clock-in and/or clock-out functions that occur via mobile device 115-a, camera 210 and/or operation of clock-in module 120. Application 505 may operate to provide communications between components of environment 500 as well as, for example, tagging photographs taken by camera 210 with other information such as time stamps, geo location stamps, etc., or providing functions such as face recognition and the like to assist in confirming identity of an employee.

Display 510 may include, for example, a digital display as part of, for example, a control panel of environment 500 (e.g., device 105). Display 510 may be part of device 105 or mobile device 115-a. Display 510 may be provided via devices such as, for example, a desk top computer or the mobile computing device 525 (e.g., mobile device 115-a) in the form of, for example, a handheld mobile device (e.g., a smartphone). In recent examples, display 510 may be either permanently mounted (e.g., mounted on a wall of a home or business), or may be a mobile device accessible via a mobile device (e.g., mobile computing device 525). The user interface 520 may be integrated into display 510. Such a user interface 520 may include a plurality of menus, screens, microphones, speakers, cameras, and other capability that permit interaction between the user and the automation and security system, or any component of environment 500. Additionally, or alternatively, user interface 520, with display 510, may be integrated into device 105, mobile device 115-a, employer device 205 or other features of the automation and security system.

Sensor 515 may include, for example, a camera sensor, an audio sensor, a forced entry sensor, a shock sensor, a proximity sensor, a boundary sensor, an appliance sensor, a light fixture sensor, a temperature sensor, a light beam sensor, a three-dimensional (3D) sensor, a motion sensor, a smoke sensor, a glass break sensor, a door sensor, a video sensor, a carbon monoxide sensor, an accelerometer, a global positioning system (GPS) sensor, a Wi-Fi positioning sensor, a capacitance sensor, a radio frequency sensor, a near-field sensor, a heartbeat sensor, a breathing sensor, an oxygen sensor, a carbon dioxide sensor, a brainwave sensor, a motion sensor, a voice sensor, a touch sensor, and the like. Device 105 and mobile device 115-a may have included or have integrated therein one or more of the sensors 515. Although sensor 515 is depicted as a separate component from device 105 and mobile device 115-a, in some embodiments, sensor 515 may be connected directly to any one of those components or other components of environment 500.

Mobile computing device 525 may be part of or have integrated therein mobile device 115-a and/or employer device 205. Mobile computing device 525 may be in the form of, for example, a tablet computing device, a smartphone, a laptop computer, or the like. In some examples, device 105 is part of mobile computing device 525. In one embodiment, device 105 may be placed at various locations at a place of business (e.g., moved to different entry points to a place of business).

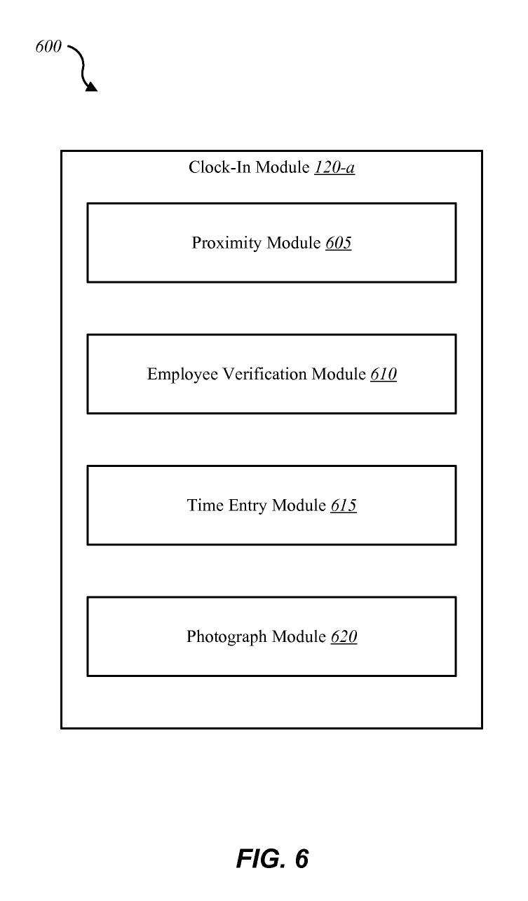

FIG. 6 is a block diagram illustrating an example clock-in module 120-a. Clock-in module 120-a may be one example of the clock-in module 120 described above with reference to FIGS. 1-5. Clock-in module 120-a may include a proximity module 605, an employee verification module 610, a time entry module 615, and a photograph module 620. In other embodiments, clock-in module 120-a may include more or fewer of the modules shown in FIG. 6. The modules of clock-in module 120-a may be operated using various components of an automation and security system, such as any of the components shown with reference to environments 100, 200, 300, 400, 500 described above with reference to FIGS. 1-5.

Proximity module 605 may operate to determine a proximity of a mobile device carried by an employee (e.g., mobile device 115) relative to a clock-in device of an automation and security system (e.g., device 105). Proximity module 605 may implement or communicate with a shortwave technology provided by, for example, shortwave device 215. The shortwave communication may involve a technology such as, for example, Bluetooth, RF, NFC, or the like. Proximity module 605 may use proximity of the employee's mobile device as one factor in the process of clocking-in and/or clocking-out the employee. For example, the proximity information may provide one indicator that the employee, who is assumed to be carrying the mobile device, is within a certain zone or range of distance of the clock-in point (e.g., device 105) at the time of clocking-in and/or clocking-out. The shortwave technology may be used because of its relatively short range capability, which requires the mobile device to be within a certain relatively close proximity to the clock-in/clock-out point in order for a proximity module 605 to identify the mobile device.

Employee verification module 610 may operate to perform any number of employee verification processes and/or methods. For example, employee verification module 610 may receive proximity information from proximity module 605 to identify a particular mobile device and then associate the mobile device with a given employee that is pre-registered or otherwise associated with the mobile device. In another example, employee verification module 610 may receive other information such as, for example, a photograph of the person carrying the mobile device and involved in the clock-in and/or clock-out process. Other types of employee verification may be used including, for example, a security code, facial recognition, fingerprint scan, security badge scan, and the like. The employee verification provided by employee verification module 610 may be used, for example, to permit and/or deny the employee to clock-in and/or clock-out.

Time entry module 615 may operate to begin or end time accrual for an employee's particular shift based on the clock-in and/or clock-out process. Time entry module 615 may provide various reports related to the hours of time worked by the employee, the time of day or day of week in which the employee works, and other information related the employee's work patterns. Furthermore, time entry module 615 may correlate the clock-in and/or clock-out times of the employee with preset standards such as minimum number of hours that the employee should work, overtime work, mandatory start and/or stop times for the employee for purposes of determining an early or late clock-in and/or clock-out, and the like.

Photograph module 620 may receive photographs of a person involved in a clock-in and/or clock-out process. Photograph module 620 may receive photographs from a mobile device carried by the employee. Alternatively, the photographs may be received from a camera associated with a clock-in and/or clock-out device (e.g., device 105, control panel, etc.), or an existing security camera of the automation and security system. Photograph module 620 may operate to compare the photograph to a stored photograph of the employee to confirm the identity of the employee. In other examples, the photograph may be transmitted by photograph module 620 to another device such as the employer device 205 for purposes of reviewing and/or storing the photograph. Photograph module 620 may time stamp, geo location stamp, or otherwise tag information to the photograph.

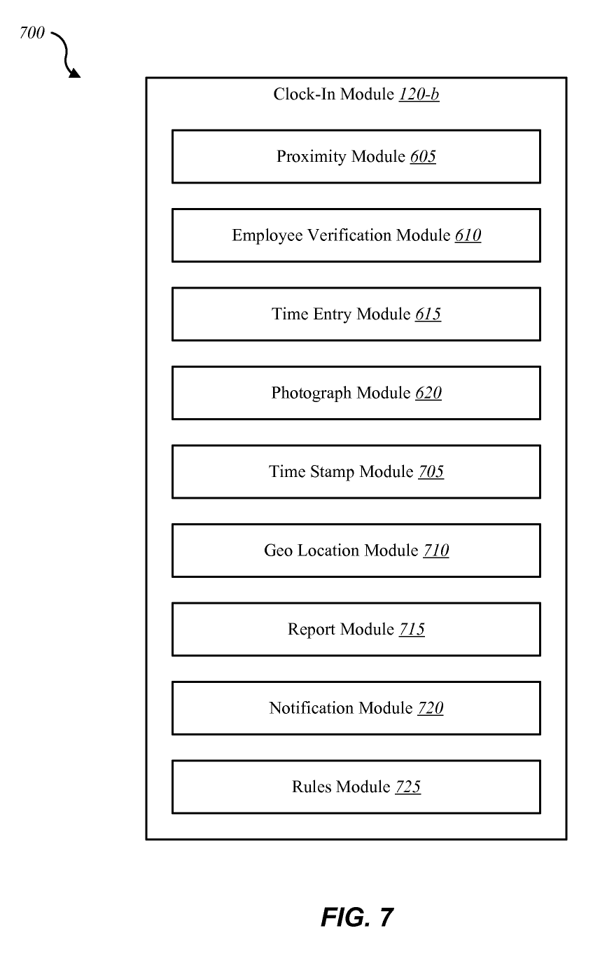

FIG. 7 is a block diagram illustrating an example clock-in module 120-b. Clock-in module 120-b may be one example of the clock-in modules 120 described above with reference to FIGS. 1-5. clock-in module 120-b may include the modules of clock-in module 120-a described with reference to FIG. 6, and may further include a time stamp module 705, a geo location module 710, a report module 715, a notification module 720, and a rules module 725. Any of the modules shown and described with reference to clock-in module 120-b may be included in any of the clock-in modules 120 described herein or in other modules, components or features of the environments 100, 200, 300, 400, 500 described above with reference to FIGS. 1-5.

Time stamp module 705 may operate to time stamp one or more steps or processes associated with a clock-in and/or clock-out procedure. For example, time stamp module 705 may time stamp a photograph taken by one or more cameras as part of a clock-in and/or clock-out procedure. Time stamp module 705 may time stamp when the employee's mobile device is identified as being within a certain proximity of a clock-in/clock-out device such as device 105. Time stamp module 705 may time stamp when the employee's mobile device or other tracking device moves outside of a given boundary such as, for example, a perimeter of a place of business or other geographic boundary.

Geo location module 710 may receive geo location information from one or more sources (e.g., geo location device 220). Geo location module 710 may provide geo location information as at least one criteria for authenticating identity of an employee and/or the location of an employee between clock-in and/or clock-out times. In one example, if the geo location data received by clock-in module 120-b does not coincide with the location of the place of business and/or specifically a clock-in/clock-out device (e.g., device 105), geo location module 710 may operate to, for example, prohibit clocking-in/clocking-out and/or generating a notification or alarm.

Report module 715 may operate to generate at least one report associated with an employee, and particularly clocking-in and/or clocking-out data associated with an employee. Report module 715 may deliver reports to an employer, supervisor, or owner via, for example, employer device 205. Report module 715 may generate numerous types of reports including, for example, reports of late and/or early clock-in/clock-out, total hours works, overtime hours worked, combinations of employees on site, unauthorized clock-outs or departures from a place of business, extended work breaks, and the like. Report module 715 may receive input from a plurality of sources, including, for example, many of the other modules of clock-in module 120-b. Information utilized by report module 715 may be based at least in part on rules established, stored, or operated by rules module 725.

Notification module 720 may generate one or more notices or alarms related to employee behavior such as clock-in and/or clock-out times, proximity of an employee to a work station, place of business, and/or a clock-in/clock-out device, and the like. In one example, notification module 720 generates a notice that is sent to an employer when an employee is more than 5 minutes delayed from a scheduled clock-in time. The notification may be sent to the employer via, for example, a text message sent to a mobile computing device, an email, or notice sent via an application operating on one or more computing devices of the employer. In another example, a notification is sent to an employee requesting a response from the employee such as, for example, when the employee is expected to clock-in, confirming that the employee is off-site from the place of business and has not clocked-out, or a warning that an early clock-out, without authorization, may result in employment termination. The employee's mobile device (e.g., smartphone) may operate an app that receives notices from notification module 720. The mobile app may provide two-way communication between the employee and clock-in module 120-b and/or the employer (e.g., via employer device 205). For example, notification module 720 may generate one or more notices to be transmitted to an employee based on instructions received from an employer. The employer instructions may be generated in response to information received from notification module 720 concerning clock-in and/or clock-out times of an employee, an employee's location at the place of business or removed from the place of business, or the like.

Clock-in module 120-b may operate at least in part based on one or more rules. The rules may be established, modified, and/or operated via rules module 725. Rules module 725 may, during installation of one or more components of an automation and security system, cause the installer to input parameters associated with rules. For example, one rule may be that an employee who attempts to clock-in more than one hour after a scheduled clock-in time is not permitted to clock-in and/or is given a notice to immediately personally communicate with an employer or supervisor. Another example rule is that an employee is not permitted to clock-out unless a certain number of hours have been logged for a given time period (e.g., day, week, shift, etc.). Another rule may be to send a notice to the employer if geo location indicates that the employee (or at least the employee's mobile device) is not at the place of business at the time of attempting to clock-in and/or clock-out. The number and type of rules that may be established via rules module 725 may be established and carried out via rules module 725 or other functionality of clock-in module 120-b are numerous and may be determined at least in part based on the type of time management software, the type of business, the number of employees, technology capabilities for the employer/supervisor and/or employee (e.g., via a mobile device), and the like.

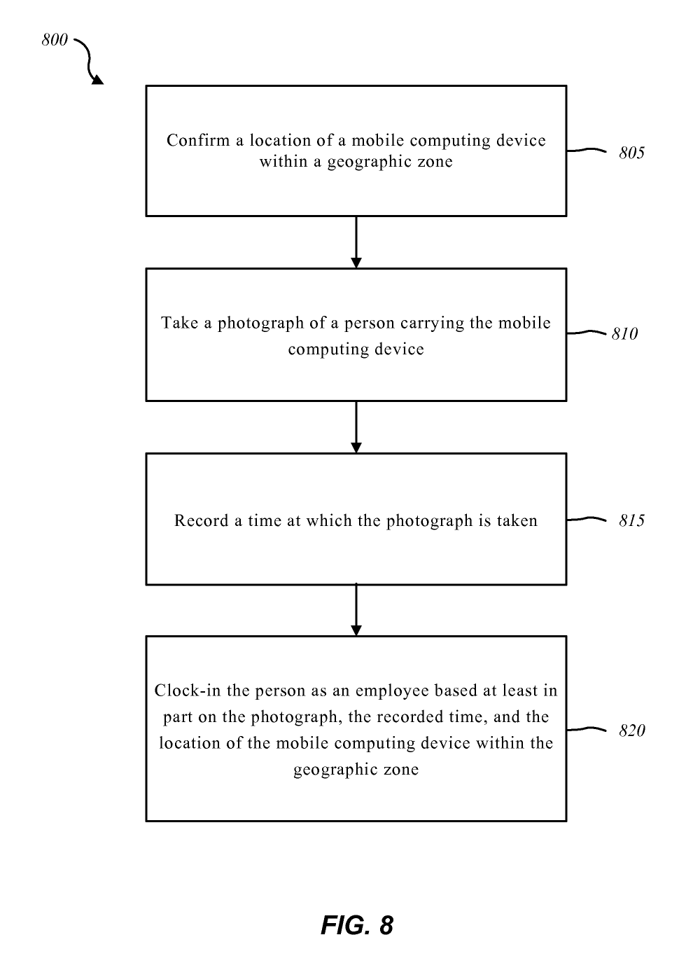

FIG. 8 is a flow diagram illustrating one embodiment of a method 800 for employee clock-in using an automation and security system. In some configurations, the method 800 may be implemented by the clock-in module 120 shown in FIGS. 1-7. In other examples, method 800 may be performed generally by device 105 or mobile device 115, or even more generally by the environments 100, 200, 300, 400, 500 shown in FIGS. 1-5.

At block 805, method 800 includes confirming a location of a mobile computing device within a geographic zone. Block 810 includes taking a photograph of a person carrying the mobile computing device. At block 815, method 800 includes recording a time at which the photograph is taken. Block 820 includes clocking-in the person as an employee based at least in part on the photograph, the recorded time, and the location of the mobile computing device within the geographic zone.

Method 800 may also include comparing the photograph with a stored photograph of an employee associated with the mobile computing device to confirm that the person is the employee. Method 800 may include confirming the presence of the mobile computing device using Bluetooth communication. Mobile computing device may include at least one employee identifier that is associated with the employee. Method 800 may include tagging the photograph with the recorded time. Method 800 may include receiving geo location information for the mobile computing device at the time the photograph is taken or when the person is clocked-in as an employee. Method 800 may include tagging the photograph with the geo location information. After clocking-in the employee, the method 800 may include confirming location of the mobile computing device within the geographic zone, taking another photograph of the person, recording a time at which another photograph is taken, and clocking-out the person based, at least in part, on the photograph, the recorded time and the confirmed location that occurred after clocking-in the employee. Method 800 may also include generating at least one report showing clock-in information for the employee for a pre-determined time. Method 800 may include generating a notice if a time for the clock-in is after an employee's scheduled shift start time. Method 800 may also include generating at least one report showing hours worked by the employee during a pre-determined time period based on clock-in and clock-out times.

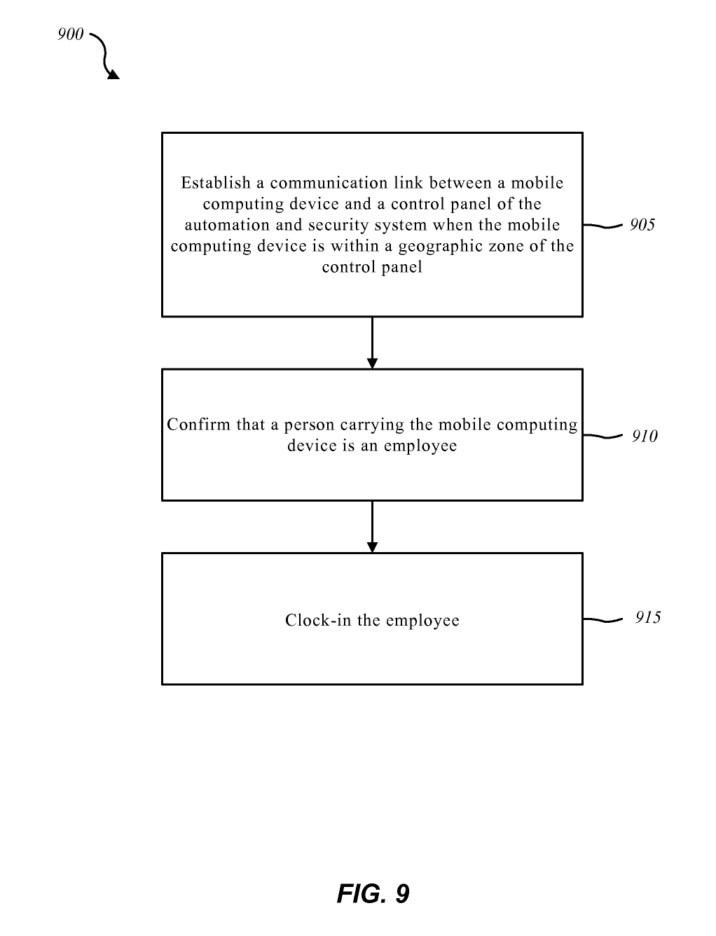

FIG. 9 is a flow diagram illustrating one embodiment of a method 900 for employee clock-in using an automation and security system. In some configurations, the method 900 may be implemented by the clock-in module 120 shown in FIGS. 1-7. In other examples, method 900 may be performed generally by device 105 or mobile device 115, or even more generally by environments 100, 200, 300, 400, 500 described with reference to FIGS. 1-5.

At block 905, method 900 includes establishing a communication link between a mobile computing device and a control panel of the automation and security system when the mobile computing device is within a geographic zone of the control panel. Block 910 includes confirming that the person carrying the mobile computing device is an employee. Block 915 includes clocking-in the employee.

The method 900 may also include taking a photograph of the person carrying the mobile computing device as part of confirming that the person is the employee. Method 900 may include tagging the photograph with at least one of time information and geo location information. After clocking-in the employee, the method 900 may include re-establishing a communication link between the mobile computing device and the control panel when the mobile computing device is within the geographic zone, confirming that the person carrying the mobile computing device is the employee, and clocking-out the employee.

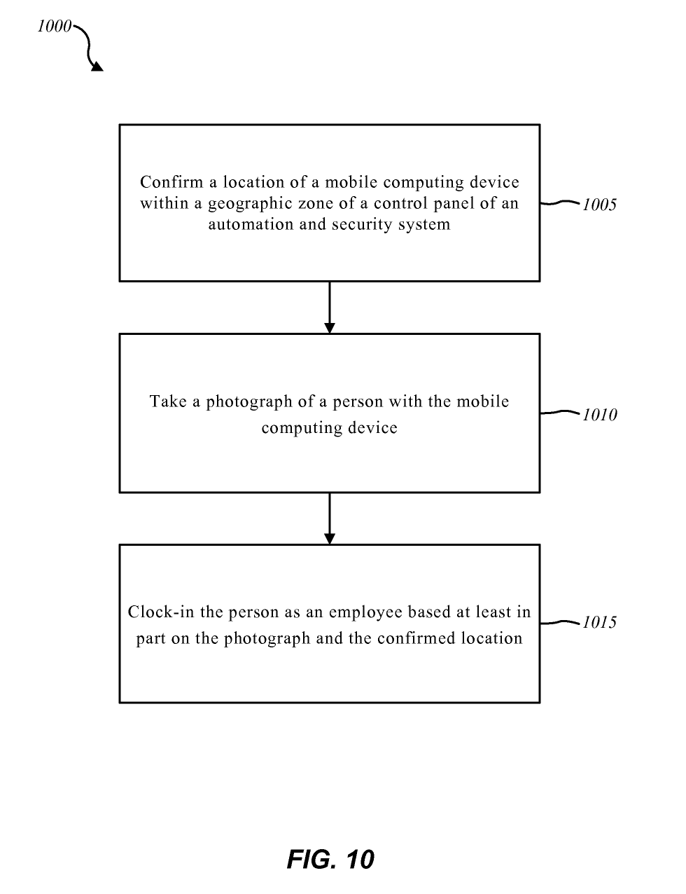

FIG. 10 is a flow diagram illustrating one embodiment of a method 1000 for employee clock-in. In some configurations, the method 1000 may be implemented by the clock-in module 120 shown in FIGS. 1-7. In other examples, method 1000 may be performed generally by device 105 or mobile device 115, or even more generally by environments 100, 200, 300, 400, 500 shown with reference to FIGS. 1-5.

At block 1005, method 1000 includes confirming a location of a mobile computing device within a geographic zone of a control panel of the automation and security system. Block 1010 includes taking a photograph of a person with a mobile computing device. Block 1015 includes clocking-in the person as an employee based at least in part on the photograph and a confirmed location.

Method 1000 may also include tagging the photograph with a time that the photograph was taken. Method 1000 may include tagging the photograph with geo location information for the mobile computing device. Method 1000 may include transmitting the photograph to a control panel of the automation and security system. After clocking-in the employee, the method 1000 may include confirming location of the mobile computing device within the geographic zone of the control panel, taking another photograph of the person with a mobile computing device, and clocking-out the person based at least in part on the photograph and the confirmed location.

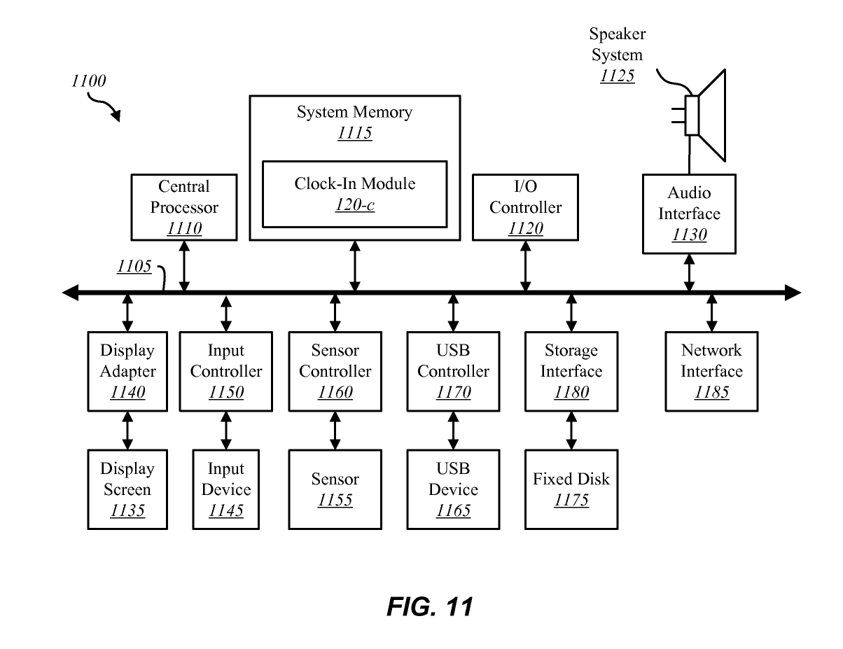

FIG. 11 depicts a block diagram of a controller 1100 suitable for implementing the present systems and methods. In one configuration, controller 1100 includes a bus 1105 which interconnects major subsystems of controller 1100, such as a central processor 1110, a system memory 1115 (typically RAM, but which may also include ROM, flash RAM, or the like), an input/output controller 1120, an external audio device, such as a speaker system 1125 via an audio output interface 1130, an external device, such as a display screen 1135 via display adapter 1140, an input device 1145 (e.g., remote control device interfaced with an input controller 1150), multiple USB devices 1165 (interfaced with a USB controller 1170), and a storage interface 1180. Also included are at least one sensor 1155 connected to bus 1105 through a sensor controller 1160 and a network interface 1185 (coupled directly to bus 1105).

Bus 1105 allows data communication between central processor 1110 and system memory 1115, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the clock-in module 120-c to implement the present systems and methods may be stored within the system memory 1115. Applications resident with controller 1100 are generally stored on and accessed via a non-transitory computer readable medium, such as a hard disk drive (e.g., fixed disk 1175) or other storage medium. Additionally, applications can be in the form of electronic signals modulated in accordance with the application and data communication technology when accessed via network interface 1185.

Storage interface 1180, as with the other storage interfaces of controller 1100, can connect to a standard computer readable medium for storage and/or retrieval of information, such as a fixed disk drive 1175. Fixed disk drive 1175 may be a part of controller 1100 or may be separate and accessed through other interface systems. Network interface 1185 may provide a direct connection to a remote server via a direct network link to the Internet via a POP (point of presence). Network interface 1185 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 1100 wirelessly via network interface 1185.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 11 need not be present to practice the present systems and methods. The devices and subsystems can be interconnected in different ways from that shown in FIG. 11. The aspect of some operations of a system such as that shown in FIG. 11 are readily known in the art and are not discussed in detail in this application. Code to implement the present disclosure can be stored in a non-transitory computer-readable medium such as one or more of system memory 1115 or fixed disk 1175. The operating system provided on controller 1100 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for employee clock-in using an automation and security system, comprising:
confirming a location of a mobile computing device within a geographic zone;
taking a photograph of a person carrying the mobile computing device;
recording a time at which the photograph is taken; and
clocking-in the person as an employee based at least in part on the photograph, the recorded time, and the location of the mobile computing device within the geographic zone.

2. The method of claim 1, further comprising:
comparing the photograph with a stored photograph of an employee associated with the mobile computing device to confirm the person is the employee.

3. The method of claim 1, further comprising:
confirming presence of the mobile computing device using Bluetooth communication.

4. The method of claim 1, wherein the mobile computing device includes at least one employee identifier that is associated with the employee.

5. The method of claim 1, further comprising:
tagging the photograph with the recorded time.

6. The method of claim 1, further comprising:
receiving geo location information for the mobile computing device at the time the photograph is taken or when the person is clocked in as an employee.

7. The method of claim 6, further comprising:
tagging the photograph with the geo location information.

8. The method of claim 1, further comprising:
after clocking-in the employee:
confirming a location of the mobile computing device within the geographic zone;
taking another photograph of the person;
recording a time at which the another photograph is taken; and
clocking-out the person based at least in part on the photograph, the recorded time, and the confirmed location that occur after clocking-in the employee.

9. The method of claim 8, further comprising:
generating at least one report showing hours worked by the employee during a predetermined time period based on clock-in and clock-out times.

10. The method of claim 1, further comprising:
generating at least one report showing clock-in information for the employee for a predetermined time period.

11. The method of claim 1, further comprising:
generating a notice if a time for the clock-in is after a scheduled shift start time for the employee.

12. An apparatus for employee clock-in using an automation and security system, comprising:
a processor;
a memory in electronic communication with the processor; and
instructions stored in the memory, the instructions being executable by the processor to:
establish a communication link between a mobile computing device and a control panel of the automation and security system when the mobile computing device is within a geographic zone of the control panel;
confirm that a person carrying the mobile computing device is an employee; and
clock-in the employee.

13. The apparatus of claim 12, wherein the instructions are executable by the processor to:
take a photograph of the person carrying the mobile computing device as part of confirming that the person is the employee.

14. The apparatus of claim 13, wherein the instructions are executable by the processor to:
tag the photograph with at least one of time information and geo location information.

15. The apparatus of claim 12, wherein the instructions are executable by the processor to:
after clocking-in the employee:
re-establish the communication link between the mobile computing device and the control panel when the mobile computing device is within the geographic zone;
confirm that the person carrying the mobile computing device is the employee; and
clock-out the employee.

16. A computer-implemented method for employee clock-in, comprising:
confirming a location of a mobile computing device within a geographic zone of a control panel of an automation and security system;
taking a photograph of a person with the mobile computing device; and
clocking-in the person as an employee based at least in part on the photograph and the confirmed location.

17. The method of claim 16, further comprising:
tagging the photograph with a time that the photograph was taken.

18. The method of claim 16, further comprising:
tagging the photograph with geo location information for the mobile computing device.

19. The method of claim 18, further comprising:
transmitting the photograph to a control panel of the automation and security system.

20. The method of claim 18, further comprising:
after clocking-in the employee:
confirming a location of the mobile computing device within the geographic zone of the control panel;
taking another photograph of the person with the mobile computing device; and
clocking-out the person based at least in part on the photograph and the confirmed location.
